(19) United States
(12) Patent Application Publication
(10) Pub. No.: US 2021/0211387 A1
(43) Pub. Date: Jul. 8, 2021

(54) ROUTE DETECTION METHOD BASED ON TUNNELING TECHNOLOGY, AND ROUTING NODE AND CENTRAL SERVER

(71) Applicant: BEIJING DA MI TECHNOLOGY CO., LTD., Beijing (CN)

(72) Inventors: Zhengping LI, Beijing (CN); Sumin DUAN, Beijing (CN); Chen WANG, Beijing (CN)

(21) Appl. No.: 17/055,717

(22) PCT Filed: Apr. 1, 2019
(86) PCT No.: PCT/CN2019/080794

§ 371 Date: Nov. 16, 2020

(30) Foreign Application Priority Data
May 17, 2018 (CN) 201810471027.7

(51) Int. Cl. H04L 12/801; H04L 12/26; H04L 12/741; H04L 12/911; H04L 12/721

(52) U.S. Cl. CPC H04L 47/29; H04L 43/16; H04L 43/0829; H04L 45/70; H04L 45/745; H04L 47/825; H04L 43/0852

(57) ABSTRACT

A route detection method performed by a first node includes sending a detection request message to an adjacent second node in a same group, receiving a detection response message returned by the second node and including a link delay and a packet loss rate, and sending a link quality message regarding a link between the first and second nodes to a central server based on the link delay and the packet loss rate. The method further includes, if the link delay exceeds a link delay threshold and/or the packet loss rate exceeds a packet loss rate threshold, sending a link routing query message to the central server, receiving a link routing response message from the central server, and modifying a local routing table based on an optimal link indicated by the link routing response message. At least one of the above messages is sent after tunnel encapsulation.

### CROSS-REFERENCE TO RELATED APPLICATION

This application claims priority to Chinese Patent Application No. 201810471027.7, filed on May 17, 2018, and entitled “ROUTE DETECTION METHOD BASED ON TUNNELING TECHNOLOGY, AND ROUTING NODE AND CENTRAL SERVER,” which is incorporated herein by reference in its entirety.

### FIELD OF TECHNOLOGY

The present disclosure relates to the field of communications technologies, and particularly, to a route detection method based on a tunneling technology, a routing node, and a central server.

### BACKGROUND

In recent years, short-term packet losses, jitters, and increased delays of links of a public network or dedicated line links between a group of server nodes in the Internet have caused network problems, such as an increase in a round-trip time (RTT) of links of message service data, or a timeout, and stopping of audio and video services. Based on the SD-WAN and intelligent network solutions, network conditions between network nodes are detected in real time, and then reported to a computing center for calculation, so as to find an optimal link between any two nodes in a network, to prevent a service from being affected by a short-term failure of an intermediate node.

If deployment of a hybrid cloud is not friendly enough, for example, some cloud devices do not support their networking on a TCP/IP layer 2 or layer 3, or an edge node and a central node of a service cluster are distinguished between, structures of the edge node and the central node are not equal, thereby making it difficult for servers deployed between different cloud vendors to avoid jitters of the public network.

### SUMMARY

According to a first aspect, a route detection method based on a tunneling technology is provided, including:
sending, by a first node, a detection request message to an adjacent second node in a same group, and receiving a detection response message returned by the second node, where the detection response message includes a link delay and a packet loss rate;
sending, by the first node, a link quality message of a link between the first node and the second node to a central server based on the link delay and the packet loss rate; and
comparing, by the first node, the link delay and the packet loss rate with a preset link delay threshold and a packet loss rate threshold; if the link delay exceeds the link delay threshold and/or the packet loss rate exceeds the packet loss rate threshold, sending a link routing query message to the central server, receiving a link routing response message sent by the central server, and modifying a routing table of this node based on an optimal link in the link routing response message, where
the messages are all sent after tunnel encapsulation.

Further, the sending a detection request message to an adjacent second node in a same group includes:
periodically sending, by the first node, the detection request message to the adjacent second node in the same group based on a first time period.

Further, the detection request message includes a TCP message and/or an ICMP message, where the TCP message is configured to detect the link delay, and the ICMP message is configured to detect the link delay and the packet loss rate.

Further, the optimal link is a link, with a highest score, obtained by the central server by performing calculation on all links from the first node to a destination node based on a uniform assignment of the link delay and a uniform assignment of the packet loss rate between nodes in the same group.

Further, the link delay and the packet loss rate are set with different weights and different assignments to calculate the optimal link.

Further, the central server further comprises setting for mandatory routing. The method further includes:
periodically querying, by the first node based on a second time period, the central server whether a mandatory routing is set; and if the mandatory routing is set, modifying a local routing table based on the mandatory routing.

Further, performing, by the first node, tunnel encapsulation on the message is specifically performing GRE tunnel encapsulation on the message, and includes adding a source address and a destination address of a tunnel to the message.

According to a second aspect, a route detection method based on a tunneling technology is provided, including:
receiving, by a central server, a link quality message that includes a link delay and a packet loss rate of a link from a first node to an adjacent second node in a same group, and storing the link delay and the packet loss rate of the link between the first node and the second node; and
in response to a link routing query message from the first node, calculating, by the central server, an optimal link from the first node to a destination node, and sending a link routing response message, so that the first node modifies a local routing table based on the optimal link, where
the messages are all sent after tunnel encapsulation.

Further, the calculating an optimal link from the first node to a destination node includes:
calculating, by the central server, scores of all links from the first node to the destination node based on a uniform assignment of the link delay and a uniform assignment of the packet loss rate between nodes in the same group, where a link with a highest score is the optimal link.

Further, the link delay and the packet loss rate are set with different weights and different assignments to calculate the optimal link.

Further, the central server further includes setting for mandatory routing, and the method further includes:
in response to the first node performing querying based on a second time period, causing the first node to modify the local routing table based on the mandatory routing.

Further, the central server stores latest three link delays and latest three packet loss rates between nodes in the same group.

According to a third aspect, a routing node is provided, including a link detection module, a routing obtaining module, and an encapsulation module, where
the link detection module is configured to send a detection request message to an adjacent second node in a same group, and receive a detection response message returned by the second node, where the detection response message includes a link delay and a packet loss rate; report a link quality message between the routing node and the second node to a central server based on the link delay and the packet loss rate; and compare the link delay and the packet loss rate with a preset link delay threshold and a packet loss rate threshold, and if the link delay exceeds the link delay threshold and/or the packet loss rate exceeds the packet loss rate threshold, notify the routing obtaining module;
the routing obtaining module is configured to send a link routing query message to the central server based on a notification of the link detection module, receive a link routing response message, and modify a routing table based on an optimal link in the link routing response message; and
the encapsulation module is configured to perform tunnel encapsulation on the to-be-sent messages.

Further, the routing obtaining module periodically queries, based on a second time period, the central server whether a mandatory routing is set; and if the mandatory routing is set, modifies a local routing table based on the mandatory routing.

Further, performing, by the encapsulation module, GRE tunnel encapsulation on the packet includes adding a source address and a destination address of a tunnel to the message.

According to a fourth aspect of the present disclosure, a central server is provided, including a central link module, a route status memory, a setting module, and an encapsulation module, where
the central link module is configured to receive a link quality message regarding a link from a first node to an adjacent second node in a same group; in response to a link routing query message from the first node, calculate an optimal link from the first node to a destination node; and send a link routing response message;
the route status memory is configured to store latest three link quality conditions between nodes in the same group;
the setting module is configured to set a link route parameter of each node; and
the encapsulation module is configured to perform GRE tunnel encapsulation on the to-be-sent messages, including adding a source address and a destination address of a tunnel to the message.

According to a fifth aspect, a computer-readable storage medium is provided, where a computer program is stored in the computer-readable storage medium, and when the program is executed by the processor, the method in the first aspect is implemented.

According to a sixth aspect, a computer device is provided, including a memory, a processor, and a computer program stored in the memory and executable on the processor, where the processor performs the method in the second aspect when executing the program.

In one or more embodiments, a route detection method based on a tunneling technology is provided, dynamic routing detection and adjustment are performed in a same group through a routing cluster with grouped generic routing encapsulation (GRE), so as to achieve high-quality communication transmission in a wide area network. Therefore, deployment of virtual private network (VPN) of different cloud vendors can be quickly broken through, thereby reducing problems caused by a decline in communication quality between an edge and a center due to network fluctuations of an operator, or reducing use of bandwidth of a dedicated line to reduce operating costs.

### BRIEF DESCRIPTION OF THE DRAWINGS

The specific implementations of the present disclosure are described below in further detail with reference to the accompanying drawings.

FIG. 1 is a schematic diagram of a scenario architecture of route detection according to one or more embodiments;

FIG. 2 is a flowchart of a route detection method according to one or more embodiments;

FIG. 3 is a schematic flowchart of a route detection method according to one or more embodiments;

FIG. 4 is a schematic structural diagram of GRE encapsulation according to one or more embodiments;

FIG. 5 is a schematic structural diagram of a routing node according to one or more embodiments;

FIG. 6 is a flowchart of a route detection method according to one or more embodiments;

FIG. 7 is a schematic structural diagram of a central server according to one or more embodiments; and

FIG. 8 is a schematic structural diagram of a computer device according to one or more embodiments.

### DESCRIPTION OF THE EMBODIMENTS

To explain the present disclosure more clearly, the present disclosure is further described below with reference to preferred embodiments and the accompanying drawings. Similar components are denoted with same reference numbers in the figures. Those skilled in the art should understand that content specifically described below is illustrative rather than restrictive, and should not limit the protection scope of the present disclosure.

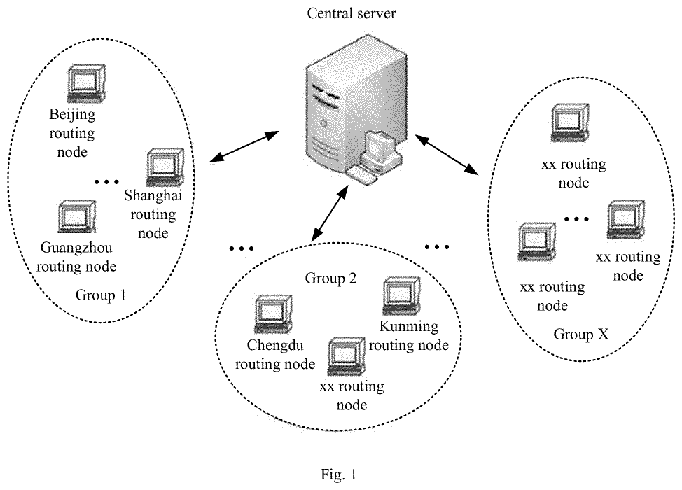

As shown in FIG. 1, in one or more embodiments, a scenario architecture of route detection includes a central server, groups, and a plurality of routing nodes in the groups. In one or more embodiments, the central server is a core of a route detection system, and is configured to receive and store a link quality status between routing nodes in real time, and calculate an optimal link from the node to a destination node according to the link quality status, so that the node modifies a routing table. In this case, when a network jitter or a link fault occurs in a wide area network, a faulty link can be bypassed by modifying the routing table, thereby preventing service transmission from being affected by the fault, and ensuring normal transmission of a communication service. In one or more embodiments, a group 1, a group 2, and a group X are pre-deployed logical groups. Performing route detection and routing adjustment in a same logical group can simplify a dynamic route detection process of a link and reduce calculation of the central server, and reduce operating costs while transmission quality is ensured. In one or more embodiments, a setting of each routing node in each group may be designed according to a service requirement, and the setting is to meet an actual application, which is not limited herein.

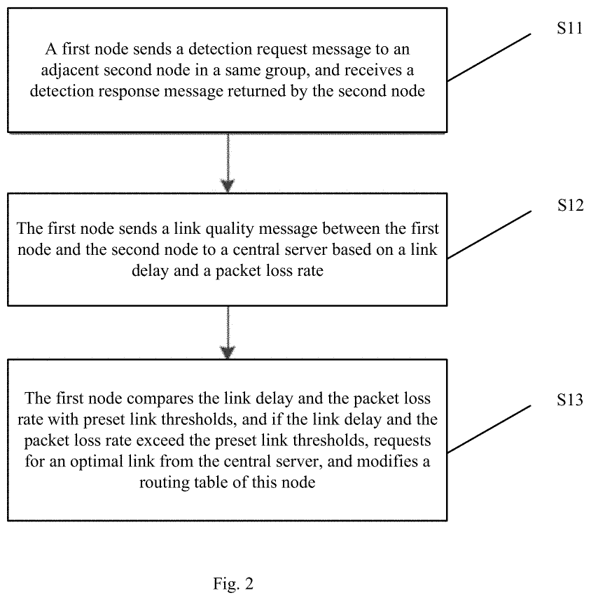

As shown in FIG. 2, a route detection method based on a tunneling technology is provided in one or more embodiments, including:

Step S11. A first node sends a detection request message to an adjacent second node in a same group, and receives a detection response message returned by the second node, where the detection response message includes a link delay and a packet loss rate.

Step S12. The first node sends link quality message of a link between the first node and the second node to a central server based on the link delay and the packet loss rate.

Step S13. The first node compares the link delay and the packet loss rate with a preset link delay threshold and a packet loss rate threshold; if the link delay exceeds the link delay threshold and/or the packet loss rate exceeds the packet loss rate threshold, the first node sends a link routing query message to the central server, receives a link routing response message sent by the central server, and modifies a routing table of this node based on an optimal link in the link routing response message, where the messages are all sent after tunnel encapsulation.

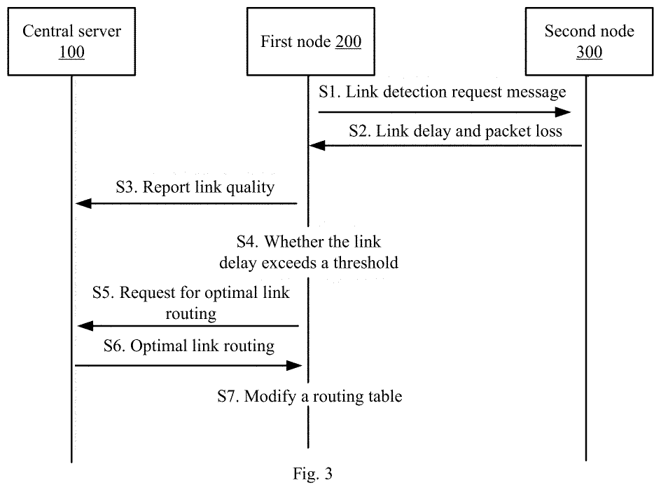

As shown in FIG. 3, in one or more embodiments, route detection is implemented by using a central server 100, a first node 200, and a second node 300, and includes step S1: the first node 200 sends a link quality detection request message to the adjacent second node 300 in a same group. In this embodiment, the same group includes a plurality of routing nodes, and each routing node sends a link quality detection request message to an adjacent routing node based on a time period, for example, sends the detection request message to the adjacent node every 5 seconds. In one or more embodiments, bidirectional detection by each routing node is supported, that is, while the first node 200 performs detection to the second node 300, the second node 300 also performs detection to the first node 200. Bidirectional detection between the two nodes may make evaluation of network performance more accurate. In one or more embodiments, the first node 200 and the second node 300 are used to describe only the route detection method, and are not limited in other manners. In one or more embodiments, the link quality detection request message includes a Transmission Control Protocol (TCP) message for detecting a link delay and/or an Internet Control Message Protocol (ICMP) message for detecting a packet loss rate and a link delay. In one or more embodiments, the first node 200 sends the TCP message and an ICMP Ping instruction message to the second node 300.

In one or more embodiments, the route detection includes step S2: the first node 200 receives a detection response message returned by the second node 300, where the detection response message includes the link delay and the packet loss rate. In one or more embodiments, the first node 200 sends the TCP message to the second node 300 to record a round-trip time (RTT) of a link, and sends the ICMP Ping instruction message to obtain a link delay and a packet loss rate on the link between adjacent nodes.

In one or more embodiments, the route detection includes S3: the first node 200 sends a link quality message about the link between the first node 200 and the second node 300 to the central server 100 based on the link delay and the packet loss rate. In one or more embodiments, the first node 200 reports link quality between the first node 200 and the second node 300 to the central server 100, and the central server 100 receives the link quality and stores the link delay and the packet loss rate that are between the first node and the second node, to update a current network status in time, thereby facilitating subsequent calculation of an optimal route.

In one or more embodiments, the route detection includes S4: the first node 200 compares the link delay and the packet loss rate with a preset link delay threshold and a packet loss rate threshold, and determines whether the link delay exceeds the link delay threshold and/or the packet loss rate exceeds the packet loss rate threshold. In one or more embodiments, while the link quality is reported to the central server 100, the first node 200 compares the link delay and the packet loss rate with the link delay threshold and the packet loss rate threshold. The link delay threshold and the packet loss rate threshold are a link delay range and a packet loss rate range for normal communication obtained through estimation by operation and maintenance staff based on a link delay and a packet loss rate when the central server 100 normally runs. The link delay threshold and the packet loss rate threshold are set by a setting unit of the central server 100, and are stored in the first node 200. If both the link delay and the packet loss rate are less than the preset link delay threshold and the packet loss rate threshold, it indicates that the link runs normally, and can continue keeping running. In one or more embodiments, if the link delay exceeds the link delay threshold and/or the packet loss rate exceeds the packet loss rate threshold, it is considered that a network fault occurs between the first node 200 and the second node 300, and routing adjustment needs to be performed.

In one or more embodiments, the route detection includes step S5: the first node 200 sends a link routing query message to the central server 100 to request for optimal link routing. That is, the first node 200 makes a request to the central server 100, to request the central server 100 to calculate an optimal link from the first node 200 to a destination node in a same group.

In one or more embodiments, the route detection includes step S6: the central server 100 sends a link routing response message to the first node 200, that is, after receiving a routing query request (the link routing query message), the central server 100 uniformly assigns the link delay and the packet loss rate based on the obtained link delays and the obtained packet loss rates that are between nodes in the same group, calculates quality scores of all links from the first node 200 to the destination node based on the assignments, and performs ranking based on the scores. A link with a highest score is considered as the optimal link from the first node 200 to the destination node. In one or more embodiments, the link delay and the packet loss rate are separately assigned based on different weights according to an actual requirement, and a more accurate optimal link is calculated based on the different weights and the assignments.

In one or more embodiments, the route detection includes step S7: the first node 200 receives the optimal link from the central server 100, and modifies a routing table of this node. That is, the first node 200 adjusts an existing routing table based on a result of route detection and route calculation, and performs service transmission based on the calculated optimal link. In one or more embodiments, the operation and maintenance staff may further set a mandatory routing by using the setting unit of the central server 100, and the first node 200 periodically queries, based on the second time period, the central server 100 whether the mandatory routing is set, for example, performs querying once every 3 seconds. In one or more embodiments, the mandatory routing has a highest priority. Regardless of whether an existing network is abnormal, or whether the central server 100 has calculated the optimal link, when the first node 200 finds that the mandatory routing exists, the routing table of this node is modified according to the mandatory routing to perform service transmission.

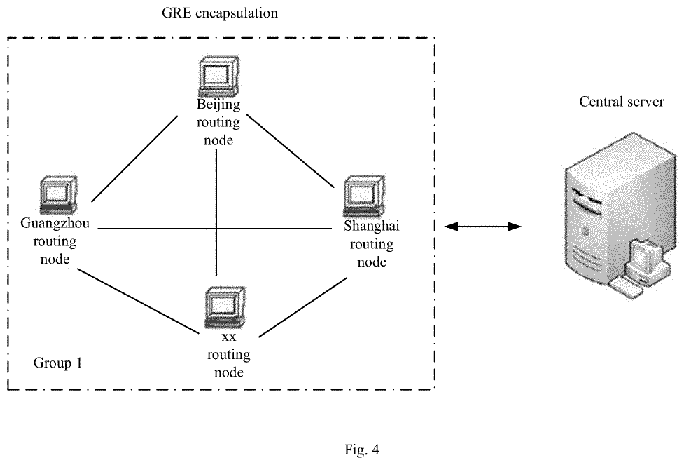

In one or more embodiments, as shown in FIG. 4, in the process of route detection and routing adjustment, to apply to different network scenarios such as the Internet data center (IDC), a hybrid cloud, and a cross-cloud platform, and to perform transmission in a heterogeneous network, GRE tunnel encapsulation is performed on the central server and each routing node, and a GRE tunnel is established in the same group. All to-be-sent messages are first sent to a source end of the tunnel, and a source address and a destination address of the tunnel determined when the tunnel is established are filled in, and the encapsulated messages are transmitted through a public network, so as to implement high-quality communication transmission in a public wide area network.

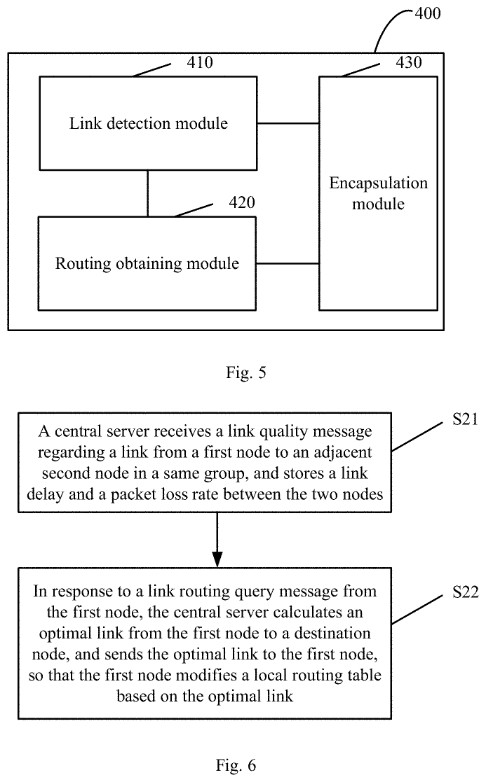

As shown in FIG. 5, in one or more embodiments, a routing node 400 is further provided and includes: a link detection module 410, a routing obtaining module 420, and an encapsulation module 430. The link detection module 410 is configured to send a detection request message to an adjacent second node in a same group, and receive a detection response message returned by the second node, where the detection response message includes a link delay and a packet loss rate; report a link quality message of a link between the routing node and the second node to a central server based on the link delay and the packet loss rate; and compare the link delay and the packet loss rate with a preset link delay threshold and a packet loss rate threshold, and if the link delay exceeds the link delay threshold and/or the packet loss rate exceeds the packet loss rate threshold, notify the routing obtaining module 420. The routing obtaining module 420 is configured to send a link routing query message to the central server based on a notification from the link detection module 410, receive a link routing response message, and modify a routing table based on an optimal link in the link routing response message. The encapsulation module 430 is configured to perform tunnel encapsulation on the to-be-sent messages.

In one or more embodiments, the link detection module 410 sends the detection request message to the adjacent node in the same group based on the first time period, for example, sends a TCP message for detecting the link delay and/or an ICMP message for detecting the link delay and the packet loss rate to the adjacent node every 5 seconds; receive the TCP message returned by the adjacent node and records a round-trip time of a link; and receives the ICMP message and records the link delay and the packet loss rate. Then, the link delay and the packet loss rate of a link between the adjacent nodes are sent to the central server, so that the central server obtains a network status in real time. In one or more embodiments, the link detection module 410 further compares the link delay and the packet loss rate with the preset link delay threshold and the packet loss rate threshold, to determine whether communication transmission between the adjacent nodes is normal and meets a service transmission requirement. If it is found that the link delay exceeds the link delay threshold and/or the packet loss rate exceeds the packet loss rate threshold, it indicates that the network status is poor and is not suitable for normal service transmission. In this case, the link detection module notifies the routing obtaining module 420 by using a User Datagram Protocol (UDP) message, so that the routing obtaining module 420 requests the central server to update the optimal link.

In one or more embodiments, after receiving a notification from the link detection module 410, the routing obtaining module 420 sends the link routing query message to the central server; requests the central server to calculate the optimal link from the routing node to a destination node in the same group; and modifies a routing table of the routing node based on the optimal link, so that the service transmission can be normally performed. In one or more embodiments, the central server further includes setting for mandatory routing, and the routing obtaining module 420 periodically queries, based on a second time period, the central server whether the mandatory routing is set, for example, performs querying once every 3 seconds. If the mandatory routing is set, regardless of whether the existing network is abnormal or the central server has calculated the optimal link, the local routing table is modified according to the mandatory routing.

In one or more embodiments, the encapsulation module 430 is configured to perform GRE tunnel encapsulation on the message which includes adding a source address and a destination address of a tunnel to the message. The process is the same as the foregoing process, and is no longer described herein.

As shown in FIG. 6, in one or more embodiments, a route detection method based on a tunneling technology is provided, including:

Step S21. A central server 100 receives a link quality message that includes a link delay and a packet loss rate of the link from a first node 200 to an adjacent second node 300 in a same group, and stores the link delay and the packet loss rate of the link between the first node and the second node.

Step S22. In response to a link routing query message from the first node 200, the central server 100 calculates an optimal link from the first node 200 to a destination node, and sends a link routing response message, so that the first node 200 modifies a local routing table based on the optimal link, where the messages are all sent after tunnel encapsulation.

In one or more embodiments, the central server 100 is a core of a route detection system, receives and stores a link quality status of the link between the routing node and an adjacent node that is reported by each routing node in each group, for example, a link delay and a packet loss rate that are between the first node 200 and the second node 300 in a group 1. In one or more embodiments, when a link between two nodes has a quality problem, for example, the link delay exceeds a predetermined link delay threshold or the packet loss rate exceeds a predetermined packet loss rate threshold, i.e., exceeds an acceptable range during normal communication, in response to a routing query sent by the routing node, the central server calculates the optimal link from the node to the destination node based on stored link quality statuses between routing nodes in a same group, so that the first node 200 can quickly adjust routing. Therefore, an original link quality problem does not affect service transmission. In one or more embodiments, the central server 100 can store latest three link delays and latest three packet loss rates between nodes in a same group, to obtain a network status in real time. In addition, when the optimal link is calculated by using the latest three link delays and the latest three packet loss rates, calculation accuracy can be effectively improved. During calculation, scores of all link lines from the first node to the destination node may be calculated by uniformly assigning the link delay and the packet loss rate that are between the nodes, and the link delay and the packet loss rate may also be set with different weights and different assignments to calculate the scores of all the links, where a link with a highest score is the optimal link, to implement link switching in time when link quality drops.

In one or more embodiments, the central server 100 includes setting for mandatory routing. In response to the routing node performing querying in a certain period of time, if the routing node sets the mandatory routing, the local routing table is modified according to the mandatory routing to implement link routing switching.

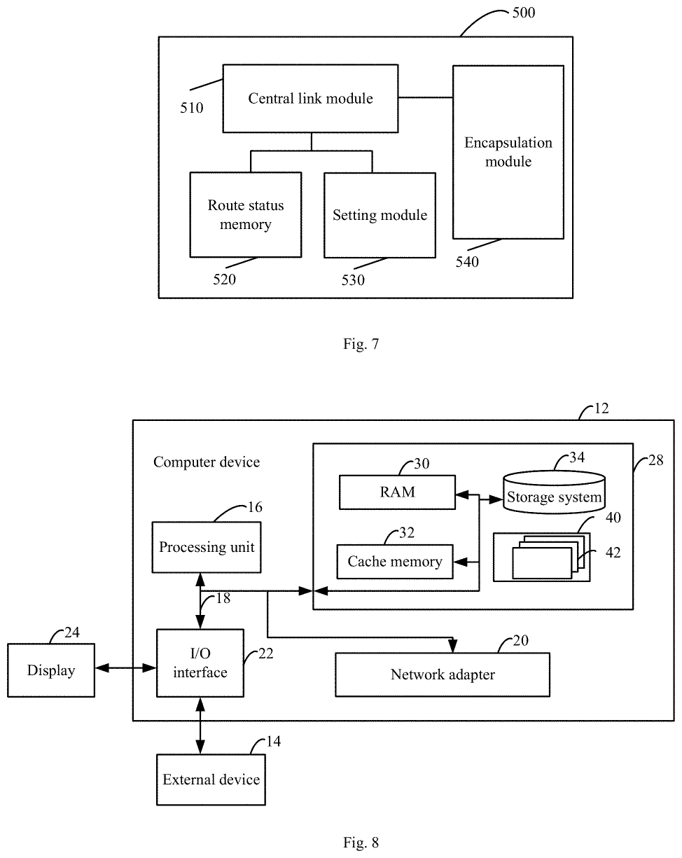

As shown in FIG. 7, correspondingly, in one or more embodiments, a central server 500 is provided, including a central link module 510, a route status memory 520, a setting module 530, and an encapsulation module 540. The central link module 510 is configured to receive a link quality message regarding a link from a first node to an adjacent second node in a same group; in response to a link routing query message from the first node, calculate an optimal link from the first node to a destination node; and send a link routing response message. The route status memory 520 is configured to store latest three link quality conditions between nodes in the same group. The setting module 530 is configured to set a link route parameter of each node. The encapsulation module 540 is configured to perform GRE tunnel encapsulation on the to-be-sent messages, including adding a source address and a destination address of a tunnel to the message.

In one or more embodiments, the central link module 510 is a core of the central server, traverses all link lines from a source node to a destination node in a same group according to a network node status received in real time, and calculates a score of each of all the link lines according to different weights representing link quality parameter items, to obtain an optimal route from the source node to the destination node, so that when an existing link encounters a fault, the source node may perform service transmission by using the optimal route, to avoid a jitter phenomenon of a public network, thereby effectively improving the timeliness of service transmission.

In one or more embodiments, the setting module 530 of the central server may run independently of the central server, for example, configured as a remote manager connected to the central server or remote management software running on a remote computer connected to the central server, so that operation and maintenance staff perform setting or management. The operation and maintenance staff can set up each logical group and perform setting on each node in a same group by using the remote manager or remote management software, such as a time interval of route detection, mandatory routing, default routing, various parameters and weights that affect routing evaluation, routing group management, and group node management. Those skilled in the art should design a architecture and an appearance of the setting module according to an actual requirement, and meeting an actual application is used as a design criterion.

In one or more embodiments, a computer-readable storage medium is provided, and stores a computer program. When the program is executed by a processor, a first node sends a detection request message to an adjacent second node in a same group, and receives a detection response message returned by the second node, where the detection response message includes a link delay and a packet loss rate. The first node sends a link quality message between the first node and the second node to a central server based on the link delay and the packet loss rate. The first node compares the link delay and the packet loss rate with a preset link delay threshold and a packet loss rate threshold; if the link delay exceeds the link delay threshold and/or the packet loss rate exceeds the packet loss rate threshold, sends a link routing query message to the central server, receives a link routing response message sent by the central server, and modifies a routing table of this node based on an optimal link in the link routing response message, where the messages are all sent after tunnel encapsulation.

In one or more embodiments, any combination of one or more computer-readable media may be used. The computer-readable medium may be a computer-readable signal medium or a computer-readable storage medium. For example, the computer-readable storage medium may be, but not limited to, an electrical, magnetic, optical, electromagnetic, infrared, or semiconductor system, apparatus, or device, or any combination thereof. More specific examples (in a non-exhaustive list) of the computer-readable storage medium include: an electrical connection to one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof. In this embodiment, the computer-readable storage medium may be any tangible medium that includes or stores a program, and the program may be used by or combined with an instruction execution system, apparatus, or device.

In one or more embodiments, the computer-readable signal medium may include a data signal propagated in a baseband or as a part of a carrier, and computer-readable program code is carried therein. This propagated data signal can take many forms, including but not limited to an electromagnetic signal, an optical signal, or any suitable combination thereof. The computer-readable signal medium may also be any computer-readable medium other than the computer-readable storage medium, and the computer-readable medium may send, propagate, or transmit a program used by or combined with the instruction execution system, apparatus, or device.

In one or more embodiments, the program code included in the computer-readable medium may be transmitted by any suitable medium, including but not limited to a wireless medium, a wire, an optical cable, RF, and the like, or any suitable combination thereof

In one or more embodiments, the computer program code used to perform operations of the present disclosure may be written in one or more programming design languages or a combination thereof. The programming design language includes an object-oriented programming language such as Java, Smalltalk, or C++, and also includes a conventional procedural program design language such as the “C” language or a similar program design language. The program code may be executed entirely on a computer of a user, partly on a computer of a user, executed as an independent software package, partly on a computer of a user and partly executed on a remote computer, or entirely executed on a remote computer or server. In a case of the remote computer, the remote computer may be connected to the computer of the user through any type of network including a local area network (LAN) or a wide area network (WAN), or may be connected to an external computer (for example, through the Internet by using an Internet service provider).

In one or more embodiments, FIG. 8 is a schematic structural diagram of a computer device. The computer device 12 shown in FIG. 8 is merely an example, and should not bring any limitation to the functions and application scope of the embodiments of the present disclosure.

In one or more embodiments, the computer device 12 is represented as a general-purpose computing device. Components of the computer device 12 may include, but are not limited to: one or more processors or processing units 16, a system memory 28, and a bus 18 connecting different system components (including the system memory 28 and the processing units 16).

In one or more embodiments, the bus 18 represents one or more of several types of bus structures, including a memory bus or a memory controller, a peripheral bus, a graphics acceleration port, a processor, or a local bus using any of a plurality of bus structures. For example, these architectures include, but are not limited to, an industry standard architecture (ISA) bus, a microchannel architecture (MAC) bus, an enhanced ISA bus, a Video Electronics Standards Association (VESA) local bus, and a peripheral component interconnection (PCI) bus.

In one or more embodiments, the computer device 12 typically includes a plurality of computer system readable media. These media can be any available media that may be accessed by the computer device 12, including volatile and non-volatile media, and removable and non-removable media.

In one or more embodiments, the system memory 28 may include a computer system readable medium in a form of a volatile memory, such as a random access memory (RAM) 30 and/or a cache memory 32. The computer device 12 may further include other removable/non-removable, volatile/non-volatile computer system storage media. For example only, a storage system 34 may be used to read from and write to non-removable and non-volatile magnetic media (not shown in FIG. 8 and generally referred to as a “hard drive”). Although not shown in FIG. 8, a disk drive for reading and writing a removable and non-volatile disk (such as a “floppy disk”) and an optical disc drive for reading and writing a removable and non-volatile optical disk (such as a CD-ROM, a DVD-ROM, or other optical media) may be provided. In these cases, each drive may be connected to the bus 18 through one or more data media interfaces. The memory 28 may include at least one program product, and the program product has a group of (for example, at least one) program modules, which are configured to perform the functions of the embodiments of the present disclosure.

A program/utility tool 40 having a group of (at least one) program modules 42 may be stored in, for example, the memory 28. Such program module 42 includes, but is not limited to, an operating system, one or more application programs, other program modules, and program data. Each or some combination of these examples may include implementation of a network environment. The program module 42 usually executes the functions and/or methods in the described embodiments of the present disclosure.

In one or more embodiments, the computer device 12 may also communicate with one or more external devices 14 (such as a keyboard, a pointing device, or a display 24), and may also communicate with one or more devices that enables a user to interact with the computer device 12, and/or any device (such as a network card or a modem) that enables the computer device 12 to communicate with one or more other computing devices. This communication may be performed through an input/output (I/O) interface 22. In addition, the computer device 12 may further communicate with one or more networks (for example, a local area network (LAN), a wide area network (WAN), and/or a public network, such as the Internet) by using a network adapter 20. As shown in FIG. 8, the network adapter 20 communicates with other modules of the computer device 12 through the bus 18. It should be understood that although not shown in FIG. 8, other hardware and/or software modules may be used in conjunction with the computer device 12, including but not limited to: microcode, a device drive, a redundant processing unit, an external disk drive array, a RAID system, a tape drive, a data backup storage system, and the like.

In one or more embodiments, the processing unit 16 executes various functional applications and data processing by running the program stored in the system memory 28, for example, implements the route detection method based on a tunneling technology provided in the embodiments of the present disclosure.

In one or more embodiments, the optimal link obtained through advanced route detection and dynamic calculation can effectively improve a convergence time of the entire network. Network nodes can be flexibly deployed by setting a logical group, and GRE tunnel encapsulation can be set to quickly traverse different network scenarios such as a hybrid cloud and a cross-cloud platform. In addition, routing adjustment in a same logical group can ensure security and stability of the system, and does not affect performance of the entire network due to a failure of a single service component, which can be applied to Internet companies of different sizes.

Obviously, the above-mentioned embodiments of the present disclosure are merely examples for clearly describing the present disclosure, and are not intended to limit the implementations of the present disclosure. For those of ordinary skill in the art, other different forms of changes may be made based on the foregoing description. It is not possible to list all the implementations herein. Any obvious changes derived from the technical solutions of the present disclosure still fall within the scope of the present disclosure.

1.-13. (canceled)

14. A route detection method comprising:
sending, by a first node, a detection request message to a second node in a same group as the first node and adjacent to the first node;
receiving, by the first node, a detection response message returned by the second node, the detection response message including a link delay and a packet loss rate;
sending, by the first node, a link quality message regarding a link between the first node and the second node to a central server based on the link delay and the packet loss rate;
comparing, by the first node, the link delay and the packet loss rate with a link delay threshold and a packet loss rate threshold, respectively; and
in response to at least one of the link delay exceeding the link delay threshold or the packet loss rate exceeding the packet loss rate threshold:
sending a link routing query message to the central server;
receiving a link routing response message sent by the central server; and
modifying a local routing table of the first node based on an optimal link indicated by the link routing response message;
wherein at least one of the detection request message, the detection response message, the link quality message, the link routing query message, or the link routing response message is sent after tunnel encapsulation.

15. The route detection method according to claim 14, wherein sending the detection request message to the second node includes:
periodically sending, by the first node, the detection request message to the second node.

16. The route detection method according to claim 15, wherein the detection request message includes at least one of:
a transmission control protocol (TCP) message configured to detect the link delay, or
an Internet control message protocol (ICMP) message configured to detect the link delay and the packet loss rate.

17. The route detection method according to claim 14, wherein the optimal link includes a link, with a highest score, obtained by the central server by performing calculation on all links from the first node to a destination node based on a uniform assignment of the link delay and a uniform assignment of the packet loss rate between nodes in the same group as the first node.

18. The route detection method according to claim 17, wherein the link delay and the packet loss rate are set with different weights and different assignments to calculate the optimal link.

19. The route detection method according to claim 14, further comprising:
periodically querying, by the first node, the central server whether mandatory routing is set; and
in response to the mandatory routing having been set, modifying the local routing table based on the mandatory routing.

20. The route detection method according to claim 14, wherein the first node performs the tunnel encapsulation on at least one of the detection request message, the link quality message, or the link routing query message by performing generic routing encapsulation (GRE) tunnel encapsulation on the at least one of the detection request message, the link quality message, or the link routing query message, including adding a source address and a destination address of a tunnel to the at least one of the detection request message, the link quality message, or the link routing query message.

21. A route detection method comprising:
receiving, by a central server, a link quality message from a first node, the link quality message including a link delay and a packet loss rate of a link from the first node to a second node in a same group as the first node and adjacent to the first node;
storing the link delay and the packet loss rate; and
in response to a link routing query message from the first node:
calculating, by the central server, an optimal link from the first node to a destination node; and
sending, by the central server, a link routing response message containing the optimal link to the first node for the first node to modify a local routing table based on the optimal link;
wherein at least one of the link quality message, the routing query message, or the link routing response message is sent after tunnel encapsulation.

22. The route detection method according to claim 21, wherein calculating the optimal link includes:
calculating, by the central server, scores of all links from the first node to the destination node based on a uniform assignment of the link delay and a uniform assignment of the packet loss rate between nodes in the same group as the first node, a link with a highest score among the all links being the optimal link.

23. The route detection method according to claim 22, wherein the link delay and the packet loss rate are set with different weights and different assignments to calculate the optimal link.

24. The route detection method according to claim 21, further comprising:
in response to a periodic query from the first node, causing the first node to modify the local routing table based on mandatory routing set in the central server.

25. The route detection method according to claim 21, wherein the central server stores latest three link delays and latest three packet loss rates of links between nodes in the same group as the first node.

26. A routing node comprising:
a processor; and
a memory storing a computer program that, when executed by the processor, causes the processor to:
send a detection request message to an adjacent node in a same group as the routing node;
receive a detection response message returned by the adjacent node, the detection response message including a link delay and a packet loss rate;
send a link quality message regarding a link between the routing node and the adjacent node to a central server based on the link delay and the packet loss rate;
compare the link delay and the packet loss rate with a link delay threshold and a packet loss rate threshold, respectively; and
in response to at least one of the link delay exceeding the link delay threshold or the packet loss rate exceeding the packet loss rate threshold:
send a link routing query message to the central server;
receive a link routing response message sent by the central server; and
modify a local routing table of the routing node based on an optimal link indicated by the link routing response message;
wherein at least one of the detection request message, the detection response message, the link quality message, the link routing query message, or the link routing response message is sent after tunnel encapsulation.

27. The routing node according to claim 26, wherein the computer program further causes the processor to:
periodically send the detection request message to the adjacent node.

28. The routing node according to claim 26, wherein the detection request message includes at least one of:
a transmission control protocol (TCP) message configured to detect the link delay, or
an Internet control message protocol (ICMP) message configured to detect the link delay and the packet loss rate.

29. The routing node according to claim 26, wherein the optimal link includes a link, with a highest score, obtained by the central server by performing calculation on all links from the first node to a destination node based on a uniform assignment of the link delay and a uniform assignment of the packet loss rate between nodes in the same group as the first node.

30. The routing node according to claim 29, wherein the link delay and the packet loss rate are set with different weights and different assignments to calculate the optimal link.

31. The routing node according to claim 26, wherein the computer program further causes the processor to:
periodically query the central server whether mandatory routing is set; and
in response to the mandatory routing having been set, modify the local routing table based on the mandatory routing.

32. The routing node according to claim 26, wherein the computer program further causes the processor to perform the tunnel encapsulation on at least one of the detection request message, the link quality message, or the link routing query message by performing generic routing encapsulation (GRE) tunnel encapsulation on the at least one of the detection request message, the link quality message, or the link routing query message, including adding a source address and a destination address of a tunnel to the at least one of the detection request message, the link quality message, or the link routing query message.
